(19) United States
(12) Patent Application Publication
(10) Pub. No.: US 2003/0080462 A1
(43) Pub. Date: May 1, 2003

(54) Extrusion die with horizontal and vertical extrudate opening adjustment

(76) Inventors: Douglas S. Nordgren, Gore, VA (US); Michael B. Shroades, Bunker Hill, WV (US)

Correspondence Address: JENKENS & GILCHRIST, P.C., 225 WEST WASHINGTON, SUITE 2600, CHICAGO, IL, 60606, US

(21) Appl. No.: 10/001,532

(22) Filed: Oct. 25, 2001

(51) Int. Cl. B29C 47/16

(52) U.S. Cl. 264/176.1; 425/466; 264/177.16

(57) ABSTRACT

An extrusion die capable of being adjustable through various thicknesses and widths while running in production without shutting down includes first and second die lips mounted on the die for vertical and horizontal movement relative to the die. The die further includes first and second horizontal adjustment mechanisms for horizontally adjusting the first and second die lips, respectively, relative to the die to adjust the width of the extrudate. The die also includes a top vertical adjuster and a bottom vertical adjuster for adjusting the thickness of the extrudate by vertically adjusting the first and second die lips relative to each other.

### FIELD OF THE INVENTION

The present invention generally relates to dies for extruding plastic webs, sheets and boards and, more particularly, to an extrusion die having vertical and horizontal lip adjustment capabilities capable of being adjusted through various thicknesses and widths of extrudate while running in production without shutting down for change over.

### BACKGROUND OF THE INVENTION

Plastic sheets, webs and boards are typically formed in extrusion dies. Extrusion dies are equipped with internal deckles to vary the thickness and width of the extrudate or resin. The deckles can only be adjusted by a small amount without having leakage. These deckles come under extreme forces due to the very high resin pressure within the die. This makes adjusting the thickness or width of the extrudate difficult while the die is operating. Consequently, when the thickness and/or width of the extrudate must be adjusted, it is necessary to shut down the die which is inefficient and increases costs since shutting down and restarting requires the die to cool down, a change over made and the die reheated. This process takes several hours of down time. Another type of deckle is solid and must be removed and a solid deckle of a different dimension inserted to adjust thickness of width of extrudate.

In addition, many dies do not have the adjustment capability quickly to adjust the vertical and horizontal dimensions of the extrudate. Often, only one of the dimensions can be adjusted which limits the utility of the die. For example, some prior art dies have only one lip (i.e., a top die lip) that can be adjusted and only in one direction.

It is desirable to provide an extrusion die for plastic sheets, webs and boards that is capable of being adjusted in four ways while the die is running in production and without shutting down the die for changeover.

### SUMMARY OF THE INVENTION

The present invention provides a die for extruding plastic sheets, webs and boards. The die can be adjusted in four ways to adjust the thickness and width of the extrudate while running in production without shutting down the die. The die includes a first die lip to which a first horizontal adjustment mechanism is coupled. This mechanism moves the first die lip horizontally relative to the die to adjust the width of the extrudate.

The die also includes a first vertical adjustment mechanism coupled to the first die lip. Upon actuation, the first vertical adjustment mechanism vertically adjusts the position of the first die lip relative to the die to adjust the thickness of the extrudate.

The die further includes a second die lip that is vertically and horizontally adjustable relative to the die and the first die lip. A second horizontal adjustment mechanism is coupled to the second die to adjust the second die lip horizontally to vary the width of the extrudate, and a second vertical adjustment mechanism is coupled to the second die lip to adjust the second die lip vertically and adjust the thickness of the extrudate.

The method of adjusting a lip assembly including a die and first and second die lips as described involves actuating the horizontal and vertical adjustment mechanisms while continuing to run the die to adjust the thickness and width of the extrudate.

### BRIEF DESCRIPTION OF THE DRAWINGS

Other objects and advantages of the invention will become apparent upon reading the following detailed description in conjunction with the drawings in which:

FIG. 1 is a perspective view of an extrusion die constructed in accordance with the principles of the present invention;

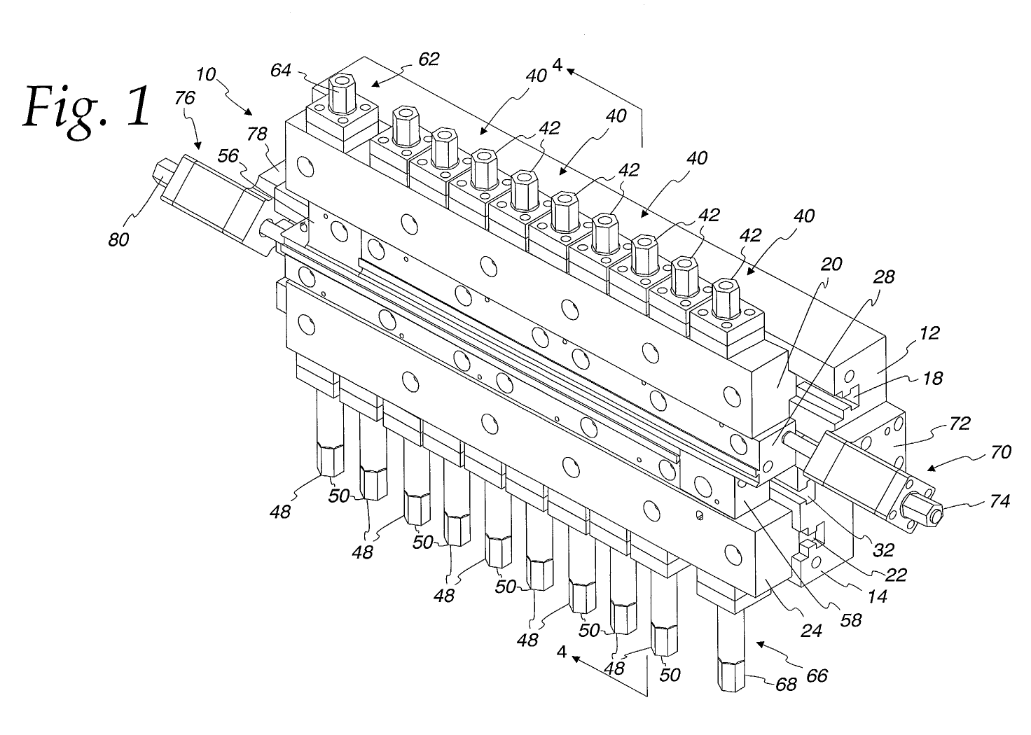

FIG. 2 is an enlarged end view of the extrusion die illustrated in FIG. 1;

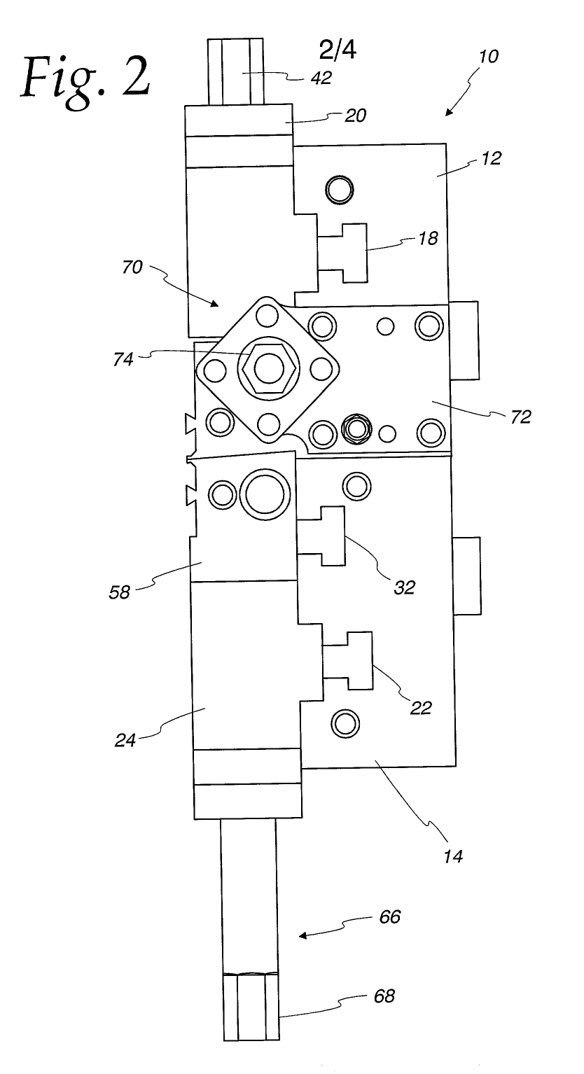

FIG. 3 is a view similar to FIG. 1 with the shaper inserts removed; and

FIG. 4 is an enlarged cross sectional view of the extrusion die taken along line 4-4 in FIG. 1.

### DETAILED DESCRIPTION OF THE PREFERRED EMBODIMENTS

Referring to the drawings, there is illustrated a four way adjustable die assembly 10 that is mounted on an extrusion die such as an EPOCH III die manufactured by Cloeren Inc. of 3240 Louis Avenue, Eau Claire, Wis. 54703. The adjustable die assembly 10 has both vertical and horizontal lip opening adjustment and can be used in the manufacture of solid or foamed plastic sheets, webs or boards and can also be applied to various forms of coating or laminating systems. The adjustable die assembly 10 is capable of being adjusted to produce various extrudate thicknesses and widths while running in production and without the need for shut down for changeover as required in the prior art. This reduces changeover time and the associated shut down and start-up scrap thereby increasing productivity and lowering cost.

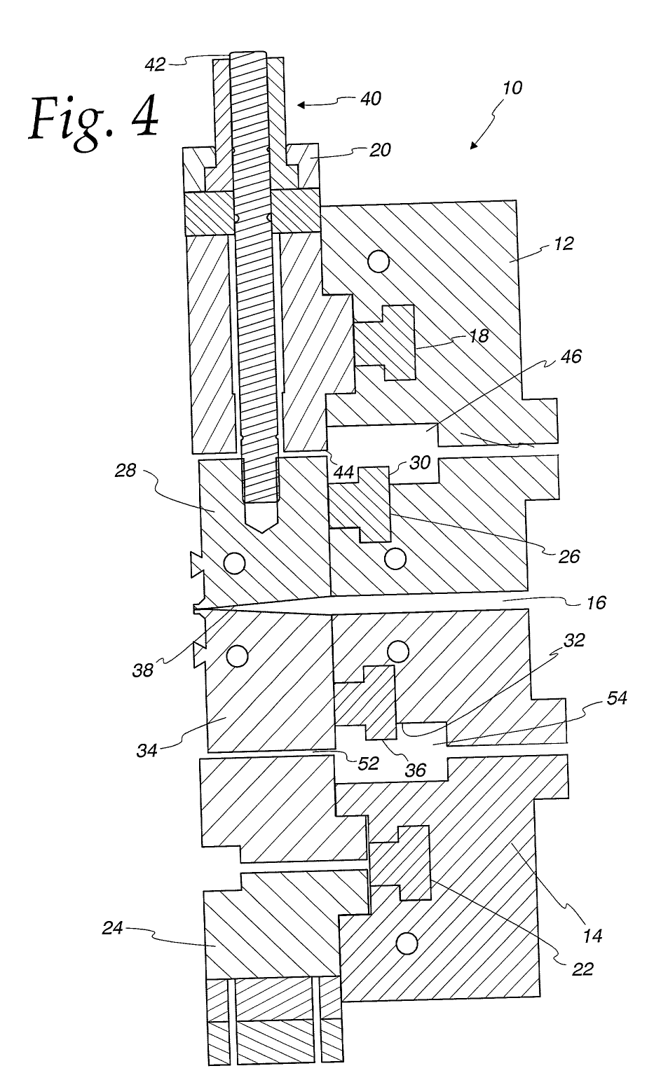

The die assembly 10 includes a top adapter 12 and a bottom adapter 14 that couples the die assembly 10 to a chosen die. A flow channel 16 (FIG. 4) for extrudate from the die is defined between the top adapter 12 and the bottom adapter 14. The top adapter 12 includes a slot 18 for coupling a top vertical adjustment mount 20 to the top adapter 12. Similarly, the bottom adapter 14 includes a slot 22 for coupling a bottom vertical adjustment mount 24 to the bottom adapter 14. The top adapter 12 also includes a slot 26 (FIG. 4) extending the length of the top adapter 12 for mounting a top die lip 28 to the die assembly 10. The top die lip 28 includes a bolt 30 the head of which is located in the slot 26. The slot 26 is configured to allow vertical and horizontal movement of the bolt 30 within the slot 26. Similarly, the bottom adapter 14 includes a slot 32 extending the length of the bottom adapter for mounting a bottom die lip 34 to the die assembly 10. The bottom die lip 34 includes a bolt 36 the head of which is located in the slot 32. The slot 32 is configured to allow vertical and horizontal movement of bolt 36 within the slot 32.

A gap 38 (FIG. 4) is defined between top die lip 28 and the bottom die lip 34 and is in communication with the flow channel 16 to define a continuous flow channel for extrudate. The thickness or vertical height of extrudate from the flow channel 16, 28 can be adjusted during production and without shutting down the die by the top vertical adjustment mount 20 and the bottom adjustment mount 24. The top vertical adjustment mount 20 includes adjustment spools 40. Each of the adjustment spools 40 includes a threaded spool 42 that is threaded into the top die lip 28 (FIG. 4). Due to a gap 44 between the top die lip 28 and the top vertical adjustment mount 20 and a space 46 in the top adapter 12 surrounding the bolt 30, threading each spool 42 moves the top die lip 28 vertically relative to the top adapter 12. This vertical movement of the top die lip 28 changes the vertical dimension of the gap 38. In this way, the thickness of the extrudate is varied without having to shut down the die.

The thickness of the extrudate can also be varied by vertically adjusting the bottom lip 34 either alone or in conjunction with vertical adjustment of the top die lip 28. The bottom vertical adjustment mount 24 includes adjustment spools 48 each with a threaded spool 50 similar to the threaded spools 42. Like the top die lip 28, there is a gap 52 between the bottom die lip 34 and the bottom vertical adjustment mount 24 and a space 54 in the bottom adapter 14 surrounding the bolt 36. By threading each spool 50, the bottom die lip 34 vertically moves relative to the bottom adapter 14 thereby changing the vertical dimension of the gap 38 and thus, the thickness of extrudate.

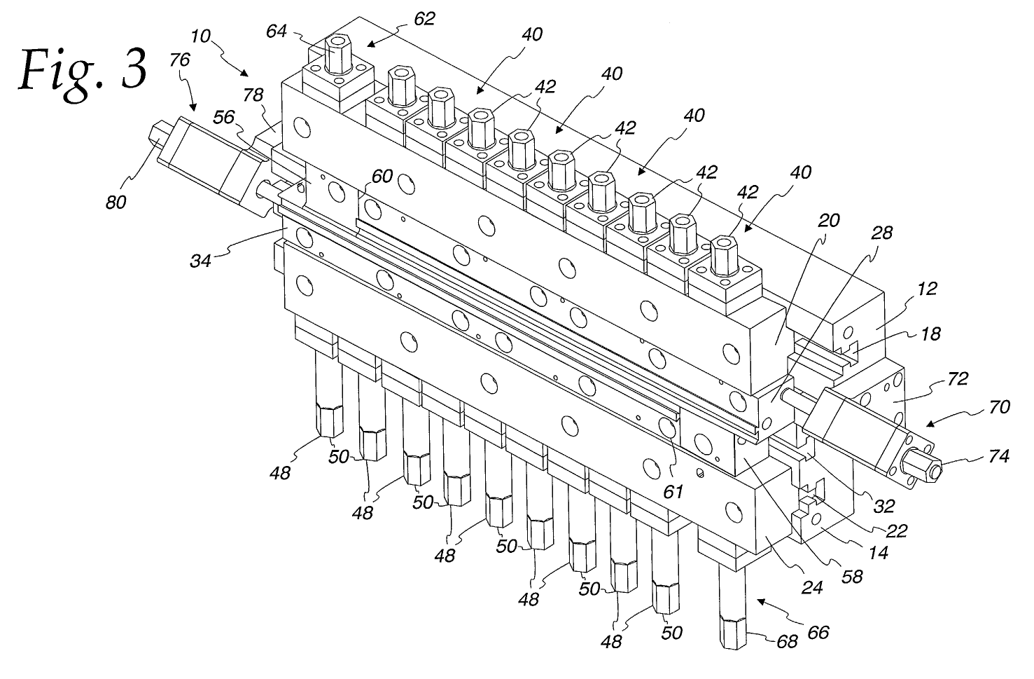

While the height of the gap 38 determines the thickness of extrudate, the length of the gap 38 determines the width of extrudate. The longitudinal ends of the gap 38 are established by a top end block 56 and a bottom end block 58. One side of the top end block 56 sealingly abuts a first end 60 of the top die lip 28 (FIG. 3) and the bottom of the top end block 56 sealingly abuts a first end 61 of the bottom die lip 34. The top end block 56 includes a bolt mounted in the slot 18 allowing the top end block 56 to move horizontally relative to the top adapter 12. A top end block adjustment spool 62 is mounted in the top vertical adjustment mount 20 and includes a threaded spool 64 that is threaded into the top end block adjustment spool 62. Threading the threaded spool 64 controls the degree of engagement to the top end block 56 with the bottom die lip 34 and thus the seal and the ability to move the top die block 56 horizontally with the top die lip 28.

In a similar manner, the bottom end block 58 includes a bolt mounted in the slot 32 which allows horizontal adjustment of the bottom end block 58 relative to the bottom adapter 14. A bottom end block adjustment spool 66 and a threaded spool 68 are also provided to control the degree of engagement of the bottom end block 58 with top die lip 28 and the horizontal adjustment of the bottom end block 58.

The slots 18, 32 extend the length of the top adapter 12 and the bottom adapter 14 allowing horizontal adjustment of the top die lip 28 and the bottom die lip 34 thereby adjusting the width of extrudate. Horizontal adjustment of the top die lip 28 is accomplished by a top horizontal adjustment mechanism 70 which is secured to the top adapter 12 and the bottom adapter 14 by a bolted plate 72. The top horizontal adjustment mechanism 70 includes a threaded spool 74 similar to the threaded spools 42, 50 previously described. By turning the threaded spool 74, the top die lip 28 and the top end block 56 are moved horizontally thereby adjusting the width of extrudate. The threaded spool 74 can be accessed during operation of the die and no shut down is required to adjust the width of the extrudate.

The bottom die lip 34 can be horizontally adjusted in a similar manner and can be horizontally adjusted either alone or along with adjustment of the top die lip 28. Horizontal adjustment of the bottom die lip 34 is accomplished by a bottom horizontal adjustment mechanism 76 is secured to the top adapter 12 and the bottom adapter 14 by a bolted plate 78. The bottom horizontal adjustment mechanism 76 includes a threaded spool 80 similar to the previously described threaded spools 42, 50, 74. By turning the threaded spool 80, the bottom die lip 34 and the bottom end block 58 are moved or adjusted horizontally to adjust the width of extrudate. As with the other threaded spools, the threaded spool 80 can be accessed during operation of the die and no shut down of the die is required for horizontal adjustment of the bottom die lip 34 and thus, the width of extrudate.

The spools 40, 42, 48, 50, 62, 66, and 74 can also be hydraulic and operated automatically.

The sealing surfaces described above are metal on metal. Other sealing surfaces can be used, however. For example, the metal sealing surfaces can be coated with polytetrafluoroethylene.

The four way adjustable die assembly 10 can adjust the thickness of extrudate by vertically adjusting either or both of the top die lip 28 and the bottom die lip 34, and can adjust the width of the extrudate by horizontally adjusting either or both of the top die lip 28 and the bottom die lip 34. This four way adjustment can be performed without shutting down the die.

What is claimed is:

1. A vertically and horizontally adjustable lip assembly for an extrusion die, comprising:
a first die lip having a first end;
a first end block adjacent to said first end of said first die lip;
a second die lip having a first end and adjacent to and spaced from said first die lip and said first end block to define a die gap between said first die lip and said first end block and said second die lip;
a second end block adjacent to said first end of said second die block;
a first adjustment mechanism coupled to said first die lip for moving said first die lip and said first end block parallel to said second die lip and said second end block to adjust extrudate width; and
a second adjustment mechanism coupled to said first die lip for moving said first die lip and said first end block perpendicular to said second die lip and said second end block to adjust extrudate thickness.

2. The vertically and horizontally adjustable lip assembly for an extrusion die claimed in claim 1 further comprising a third adjustment mechanism coupled to said second die lip for moving said second die lip and said second end block parallel to said first die lip to adjust extrudate width.

3. The vertically and horizontally adjustable lip assembly for an extrusion die claimed in claim 1 further comprising a fourth adjustment mechanism coupled to said second die lip for moving said second die lip and said second end block perpendicular to said first die lip and said first end block to adjust extrudate thickness.

4. The vertically and horizontally adjustable lip assembly for an extrusion die claimed in claim 1 wherein said lip assembly is mounted on an outside surface of said die, and said first adjustment mechanism and said second adjustment mechanism being operable during operation of said extrusion die to adjust said width and thickness of said extrudate.

5. An adjustable lip assembly for an extrusion die for adjusting the width and thickness of extrudate during operation of the die, comprising:
a first die lip having a first end;
a first end block adjacent to said first end of said first die lip;
a second die lip parallel and adjacent to said first die lip and said first end block, said second die lip spaced from said first die lip to define a gap therebetween, said second die lip including a first end;
a second and block adjacent to said first end of said second die lip;
a first mechanism for moving one of said first die lip and said first block and said second die lip and said second block parallel to the other of said first die lip and said first block and said second die lip and said second block during operation of the die to widen and narrow the width of said gap; and
a second mechanism for moving one of said first die lip and said first block and said second die lip and said second block perpendicular to said other of said first die and said first block and said second die lip and said second block to increase and decrease the height of said gap.

6. The adjustable lip assembly claimed in claim 5, comprising a third mechanism for moving vertically the other of said first die lip and said first block and said second die lip and said second block not moved by said first mechanism.

7. The adjustable lip assembly claimed in claim 5, comprising a fourth mechanism for moving horizontally the other of said first die lip and said first block and said second die lip and said second block not moved by said second mechanism.

8. An adjustable foam die assembly, comprising:
a top adaptor;
a bottom adaptor;
a top die lip, said top die lip mounted on said top adaptor to allow vertical and horizontal movement of said top die lip relative to said top adaptor;
a bottom die lip, said bottom die lip mounted on said bottom adapter to allow vertical and horizontal movement of said bottom die lip relative to said bottom adaptor;
a first horizontal adjustment mechanism coupled to said top die lip for moving said top die lip horizontally relative to said top adaptor and said bottom lip;
a second horizontal adjustment mechanism coupled to said bottom die lip for moving said bottom die lip horizontally relative to said bottom adaptor and said top lip;
a top vertical adjustment mount secured to said top lip for vertically adjusting said top lip relative to said bottom lip and said top adaptor; and
a bottom vertical adjustment mount secured to said bottom lip for vertically adjusting said bottom lip relative to said top lip and said bottom adaptor.

9. The adjustable foam die assembly claimed in claim 8 further comprising a first end block mounted adjacent to said top die lip and moveable horizontally and vertically therewith by said first horizontal adjustment mechanism and said top vertical adjustment mount, and a second end block mounted adjacent to said bottom die lip and moveable horizontally and vertically therewith by said second horizontal adjustment mechanism and said bottom vertical adjustment mount.

10. A method of adjusting a lip assembly for an extrusion die to adjust the width and height of extrudate, comprising:
providing a die with a first die lip mounted on said die for horizontal and vertical movement relative to said die;
providing a second die lip mounted on said die adjacent to said first die lip for horizontal and vertical movement relative to said die, and said first die lip;
providing a first horizontal adjustment mechanism coupled to said first die lip; and
actuating said first horizontal adjustment mechanism to move said first die lip horizontally relative to said die and said second die lip to adjust the width of extrudate.

11. The method of adjusting a lip assembly for an extrusion die set forth in claim 10, further comprising:
providing a second horizontal adjustment mechanism coupled to said second die lip; and
actuating said second horizontal adjustment mechanism to move said second die lip horizontally relative to said first die lip and said die to adjust the width of extrudate.

12. The method of adjusting a lip assembly for an extrusion die set forth in claim 10, further comprising:
providing a top vertical adjuster mounted on said first die lip; and
actuating said top vertical adjuster to move said first die lip vertically relative to said die and said second die lip to adjust the height of said extrudate.

13. The method of adjusting a lip assembly for an extrusion die set forth in claim 10, further comprising:
providing a bottom vertical adjuster mounted on said second die lip; and
actuating said bottom vertical adjuster to move said second die lip vertically relative to said die and said first die lip to adjust the height of said extrudate.

14. A method of adjusting the width and thickness of an extrudate from a die while the die is operating, comprising:
providing a die for producing extrudate;
providing a top die lip;
providing a top mounting assembly on said die for mounting said top die lip to said die to allow horizontal and vertical movement of said top die lip relative to said die;
providing a bottom die lip;
providing a bottom mounting assembly on said die for mounting said bottom die lip to said die to allow horizontal and vertical movement of said bottom die lip relative to said die;
mounting said top die lip on said top mounting assembly;
mounting said bottom lip on said bottom mounting assembly in a position to define an adjustable gap between top lip and said bottom lip;
providing a top horizontal adjustment mechanism coupled to said top die lip;
providing a top vertical adjustment mechanism coupled to said top die lip; and
actuating said top horizontal adjustment mechanism to move said top die lip horizontally relative to said bottom die lip to adjust the width of extrudate.

15. The method of adjusting the width and thickness of an extrudate claimed in claim 14, comprising:
actuating said top vertical adjustment mechanism to move said top die lip vertically relative to said bottom die lip to adjust said gap and the thickness of extrudate.

16. The method of adjusting the width and thickness of an extrudate claimed in claim 14, comprising:
providing a bottom horizontal adjustment mechanism coupled to said bottom die lip; and
actuating said bottom horizontal adjustment mechanism to move said bottom die lip horizontally relative to said top die lip to adjust the width of extrudate.

17. The method of adjusting the width and thickness of an extrudate claimed in claim 14; comprising:
providing a bottom vertical adjustment mechanism coupled to said bottom die lip; and
actuating said bottom vertical adjustment mechanism to move said bottom die lip vertically relative to said top die lip to adjust the thickness of extrudate.
